(19) United States
(12) Patent Application Publication
(10) Pub. No.: US 2002/0166345 A1
(43) Pub. Date: Nov. 14, 2002

(54) Resin coating device for optical fiber

(75) Inventors: Yasuhiro Naka, Tokyo (JP); Sinpei Todo, Tokyo (JP); Nobuaki Orita, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co, Ltd., Tokyo (JP)

(21) Appl. No.: 10/079,859

(22) Filed: Feb. 22, 2002

(30) Foreign Application Priority Data
Mar. 14, 2001 (JP) 2001-071941

(51) Int. Cl. C03C 25/10

(52) U.S. Cl. 65/529

(57) ABSTRACT

There is provided an optical-fiber resin coating device which can uniformly coat resin on an optical fiber at a high fiber-pulling velocity while preventing thickness deviation, outer-diameter variation and breaking of the optical fiber. The optical-fiber resin coating device includes a coating die (2N) with a coating die hole (6N) having at least a taper hole portion (6Na) and a land hole portion (6Nb), a nipple (1) having a nipple hole (5), and at least one intermediate die (2A) disposed between the coating die (2N) and the nipple (1) and having an intermediate die hole (6A). The inner diameter of the intermediate die hole (6A) of the intermediate die (2A) is smaller than the inner diameter of the inlet of the taper hole portion (6Na) of the coating die (2N) and equal to 1.5 times or more and 4 times or less of the inner diameter of the land hole portion (6Nb) of the coating die (2N), the angle of the taper hole portion (6Na) of the coating die (2N) is equal to 8 degrees or less, and the length of the taper hole portion (6Na) of the coating die (2N) is equal to 12 mm or more.

### FIELD OF THE INVENTION

The present invention relates to an optical-fiber resin coating device for applying protection coating onto a drawn optical fiber.

### BACKGROUND OF THE INVENTION

FIG. 2 is a schematic diagram showing a conventional resin coating device for optical fibers. According to the resin coating device for optical fibers shown in FIG. 2, a nipple 1 and a coating die are combined into an assembly 3. A resin supply channel 4 is provided to the gap between the superposing faces of the nipple 1 and the coating die 2. A nipple hole 5 of the nipple 1 and a coating die hole 6 of the coating die 2 are formed in the assembly 3 so as to be concentric with each other. The nipple hole 5 is constructed by a taper hole portion 5a and a land hole portion 5b. The coating die hole 6 is constructed by a taper hole portion 6a and a land hole portion 6b. Further, an annular resin reserving chamber 7 is equipped in the assembly 3 so as to be concentric with the nipple hole 5 and the coating die hole 6. Resin 9 is supplied from a resin supply port 8 into the resin reserving chamber 7.

An optical fiber 10 is passed through the nipple hole 5 and the die hole 6. The optical fiber 10 is coated with the resin 9 which is supplied from the resin reserving chamber 7 through the resin supply channel 4 into the coating die hole 6 under pressure. Thereafter, an optical fiber core 11 is manufactured through a coating hardening device (not shown) in the next step. At this time, meniscus 12 serving as the boundary face between the resin 9 and the optical fiber 10 is formed at the outlet of the nipple hole 5, and a circulating flow 13 of resin 9 is formed in the taper hole portion 6a of the coating die 2.

This type of optical-fiber resin coating device is generally disposed at the downstream side of an optical-fiber pulling device to apply coatings to drawn optical fibers, and the fiber-pulling and coating operations of optical fibers are continuously carried out.

In the optical-fiber resin coating device thus constructed, when the fiber-pulling velocity of the optical fiber 10 is high (high bit-rate), the coating cannot be uniformly applied to the optical fiber. That is, so-called thickness deviation occurs and the outer diameter of the optical fiber core 11 is varied. Therefore, the increase of the fiber-pulling velocity is restricted.

### SUMMARY OF THE INVENTION

The present invention provides an improved resin coating device for optical fibers.

An optical-fiber resin coating device according to an aspect of the present invention comprises:

a nipple having a nipple hole through which an optical fiber is passed;

an intermediate die having an intermediate die through the optical fiber is passed; and

a coating die having a coating die hole through which the optical fiber is passed, the nipple, the intermediate die and the coating die being successively and superposedly disposed in the order from the upstream side to the downstream side so that the nipple hole, the intermediate die hole and the coating die hole are concentric with one another, and said coating die hole comprising a taper hole portion that is reduced in diameter in the travel direction of the optical fiber from the inlet port side of said coating die hole while having an angle of θ, and a land hole portion intercommunicating with the terminal of the taper hole portion and extending to the outlet of said coating die hole, wherein the inner diameter of the intermediate die hole is set to be smaller than the inner diameter of the inlet port of the taper hole portion of the coating die hole, the inequality: 1.5dₙ(out)≦d₁<4dₙ(out) is satisfied when the inner diameter of the intermediate die hole is represented by d₁ and the inner diameter of the land hole portion of the coating die hole is represented by dₙ (out), the angle θ of the taper hole portion of the coating die satisfies: θ≦8°, and the length Lₙ₁ of the taper hole portion of the coating die satisfies: 12 mm≦Lₙ₁.

### BRIEF DESCRIPTION OF THE DRAWINGS

Exemplified embodiments of the invention will now be described in conjunction with drawings in which:

FIG. 1 is a diagram showing the main part of an embodiment of a resin coating device for optical fibers according to the present invention;

FIG. 2 is a longitudinally-sectional view showing a conventional resin coating device for optical fibers; and

FIG. 3 is a longitudinally-sectional view showing a resin coating device for optical fibers which is previously proposed in a Japanese Patent Application.

### DETAILED DESCRIPTION

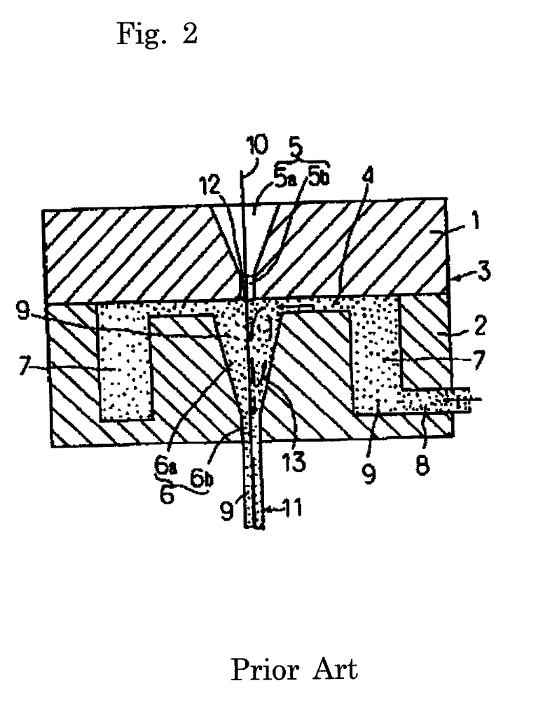

As described above, the fiber-pulling velocity is restricted when the conventional device shown in FIG. 2 is used. In order to increase the fiber-pulling velocity, there has been attempted a method of specifying the sectional area of the resin supply channel 4 and structural parameters such as the angle, length, etc. of the taper hole portion 6a of the coating die 2 to thereby prevent occurrence of thickness deviation and variation in outer diameter as disclosed in a Japanese Patent Application (Patent Number: 7-91092), for example.

In the optical-fiber resin coating device disclosed in Japanese Patent Application (Patent No. Hei-7-91092), however, even when the structural parameters are specified, thickness deviation and variation of outer diameter occur when the fiber-pulling velocity is a higher bit-rate than 1200 m/minute although an excellent result is achieved when the fiber-pulling velocity is equal to about 1000 m/minute or less.

This is because the circulating flow 13 of the resin 9 formed in the coating die 2 is more readily disturbed when the fiber-pulling velocity is a higher bit-rate. Accordingly, vibration occurs in the optical fiber 10 or meniscus 12 formed at the outlet of the nipple hole 5 is unstable. Therefore, the flow state of the resin 9 formed in the coating die 2 cannot be greatly varied by merely optimizing the structural parameters as described above, and thus the factors causing the thickness deviation and the outer-diameter variation cannot be removed.

Further, the disturbance of the circulating flow 13 as described above may cause the resin to leak to the inlet side of the nipple hole 5. If the worst comes to the worst, the leaking resin is solidified, so that it may damage the optical fiber 10 inserted into the nipple hole 5 and thus induce breaking of the optical fiber 10.

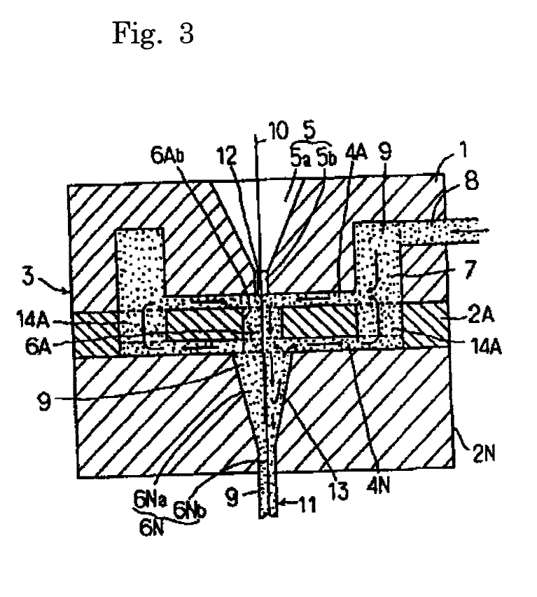

Therefore, in order to avoid this problem, a resin coating device for optical fibers as shown in FIG. 3 has been disclosed in Japanese Patent Application (Laid-open Patent Application No. Hei-11-60288) filed by the same assignee (THE FURUKAWA ELECTRIC CO., LTD.) as this application. This device has a coating die 2N having a coating die hole 6N, a nipple 1 having a nipple hole 5 and an intermediate die 2A having an intermediate die hole constructed by only a land hole portion 6Ab. The coating die hole 6N has a taper hole portion 6Na and a land hole portion 6Nb. The intermediate die 2A is disposed between the coating die 2N and the nipple 1.

In the resin coating device shown in FIG. 3, resin 9 supplied from a resin supply port 8 is passed from a resin reserving chamber 7 through a resin supply channel 4A into the land hole portion 6Ab of the intermediate die 2A and then introduced into the taper hole portion 6Na of the coating die 2N.

A part of the resin at the inlet side of the taper hole portion 6Na of the coating die 2N is leaked through a resin channel 4N formed between the coating die 2N and the intermediate die 2A and an intercommunication hole 14A into the resin reserving chamber 7, whereby the velocity of the resin circulating flow 13 occurring in the taper hole portion 6Na can be reduced. Therefore, the velocity energy caused by the circulating flow 13 can be moderated, and disturbance hardly occurs in the circulating flow 13 even when the fiber-pulling velocity is a high bit-rate, so that occurrence of the thickness deviation and the outer-diameter variation of the coating resin of the optical fiber core 11 can be prevented.

The circulating flow 13 of the resin 9 occurring in the taper hole portion 6Na hardly affects the flow of the resin 9 in the neighborhood of the meniscus 12 formed around the outlet of the nipple hole 5, and the effect of the circulating current 13 on the meniscus 12 can be suppressed. Therefore, the resin 9 can be stably coated on the optical fiber 10.

However, even when the intermediate die 2A is disposed between the coating die 2N and the nipple 1 as described above, there is also such a problem that the thickness deviation and the outer-diameter variation occur when the fiber-pulling velocity is a higher bit-rate over 1500 m/minute.

According to an aspect of the present invention, there is provided an optical-fiber resin coating device which can uniformly coat an optical fiber with resin at a high fiber-pulling velocity over 1500 m/minute to thereby prevent occurrence of thickness deviation, outer-diameter variation and breaking.

The present invention has been implemented through earnest experiments, and it specifies the structural parameters of the intermediate die and the coating die in the coating device having the coating die, the nipple and the intermediate die. By specifying the structural parameters, the circulating flow of resin at the taper hole portion of the coating die is hardly disturbed even at a fiber-pulling velocity over 1500 m/minute, and occurrence of the thickness deviation and the outer-diameter variation of the coating resin of the optical fiber core and adverse effects such as breaking of the optical fiber, etc. can be prevented.

The resin circulating flow occurring in the taper hole portion of the coating die hardly affect the flow of resin in the neighborhood of the meniscus formed around the outlet of the nipple hole, and the effect of the circulating current on the meniscus can be suppressed. Therefore, the resin can be stably coated on the optical fiber.

In the present invention, the number of the intermediate die to be interposed at the intermediate position between the nipple and the coating die is not limited to one, and a plurality of intermediate position may be disposed.

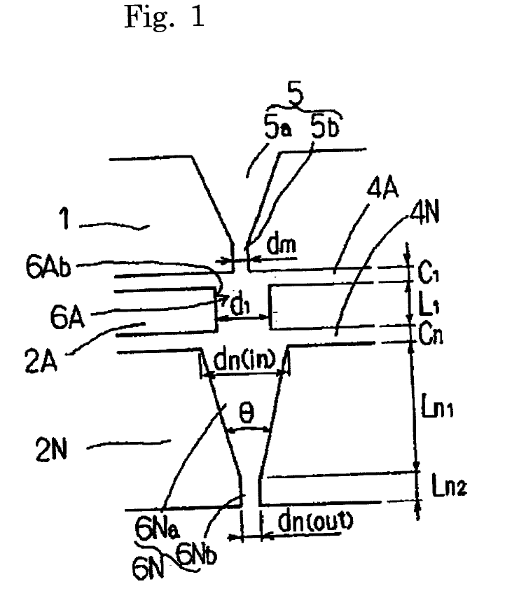

FIG. 1 shows the construction of the detailed portion of the optical-fiber resin coating device according to an embodiment of the present invention.

The optical-fiber resin coating device of this embodiment is achieved by specifying the shape of the main part of the optical-fiber resin coating device shown in FIG. 3.

In the optical-fiber resin coating device according to the embodiment of the present invention, the intermediate die 2A having the intermediate die hole 6A is stacked between the coating die 2N having the coating die hole 6N and the nipple 1 having the nipple hole 5 so that the coating die hole 6N, the intermediate die hole 6A and the nipple hole 5 are concentric with one another as shown in FIG. 3. Here, the intermediate die hole 6A of the intermediate die 2A has only a land hole portion 6Ab. The coating die hole 6N comprises a taper hole portion 6Na and a land hole portion 6Nb. An assembly 3 is constructed by the nipple 1, the intermediate die 2A and the coating die 2N.

A resin supply channel 4A is formed in the gap at the center side between the superposing faces of the nipple 1 and the intermediate die 2A.

Furthermore, a resin channel 4N serving as a leaking channel for leaking a part of the resin 9 at the inlet side of the taper hole portion 6Na from the gap between the coating die 2N having the taper hole portion 6Na and the intermediate die 2A disposed above the coating die 2N is provided at the center side between the superposing faces of the coating die 2N and the intermediate die 2A.

Still furthermore, plural intercommunication holes 14A (see FIG. 3) through which the resin channel 4N intercommunicates with the resin reserving chamber 7 are formed dispersively in the peripheral direction at the positions corresponding to the resin reserving chamber 7.

The feature of this embodiment resides in that the hole diameter d₁ of the land hole portion 6Ab constituting the intermediate die hole 6A of the intermediate die 2A is set to be smaller than the hole diameter dₙ (in) of the inlet of the taper hole portion 6Na of the coating die 2N as shown in FIG. 1. Further, the inner diameter d₁ of the land hole portion 6Ab of the intermediate die 2A and the inner diameter dₙ (out) of the land hole portion 6Nb of the coating die 2N are set to satisfy the following relationship: 1.5dₙ (out)≦d₁≦4dₙ(out).

It is preferable that the angle θ of the taper hole portion 6Na of the coating die 2N is set to 8 degrees or less (θ<8°), and the length Ln1 of the taper hole portion 6Na of the coating die 2N is set to 12 mm or more (12 mm≦Ln1).

It is preferable that the length Ln1 of the taper hole portion 6Na of the coating die 2N is longer than 12 mm, however, if the length Ln1 is increased to be longer than a required one, adverse effects such as thickness deviation, outer-diameter variation, breaking, etc. of the coating of the optical fiber core 11 may occur due to the friction between the resin 9 and the taper hole portion 6Na of the coating die 2N, etc. Therefore, with respect to Ln1, the optimum values are experimentally determined within the range satisfying the condition: 12 mm≦Ln1.

In this embodiment, the intermediate die hole 6A of the intermediate die 2A has only the land hole portion 6Ab. However, the intermediate die hole 6A may also have a taper portion or may have only a taper portion.

Next, the embodiment of the present invention will be described on the basis of actual coating treatment results of optical fibers by comparing this embodiment with a comparative example and a prior art. The overall construction of the optical-fiber resin coating device of this embodiment is substantially the same as shown in FIG. 3, however, the structural parameters of the main part shown in FIG. 1 are specified by the structural parameters of this embodiment. The comparative example has the construction shown in FIG. 3, however, it uses different structural parameters from those of the present invention as the structural parameters of the main part shown in FIG. 1. The prior art has the structure shown in FIG. 2. The respective optical-fiber resin coating devices were used for the samples of the embodiment and the comparative example. By using each optical-fiber resin coating device, two layers of urethane acrylate resin 9 (primary coating has an outer diameter of about 160 to 190 μm) were coated on an optical fiber 10 having a diameter of about 125 μm at a fiber-pulling velocity of 1000 to 2000 m/minute to manufacture an optical fiber core 11 having an outer diameter of about 245 μm. In this case, the viscosity of resin was equal to 2000 cP or less and the resin supply pressure was equal to about 0.4 Mpa. The two-layered coating was carried out by disposing two optical-fiber resin coating devices in a tandem arrangement in an optical-fiber travelling path and performing a primary coating operation at the upstream side by using the upstream-side device while performing a secondary coating operation at the downstream side by using the downstream-side device.

The optical-fiber resin coating device having the structure shown in FIG. 2 was used for the sample of the prior art, and the optical fiber core 11 was manufactured in the same manner as the embodiment and the comparative example. The resin supply pressure was equal to about 0.7MPa, which was higher than that of this embodiment. The coating device was designed to have high resistance to pressure.

Table 1 shows the dimension and angle (control factor) of each part in the optical-fiber resin coating devices used when the secondary coating was formed. Characters used in the table 1 represent the dimension and angle of each part shown in FIG. 1, and the corresponding numerical values mean the values of the respective parts. L₁ represents the dimension in the height direction of the intermediate die 2A, dm represents the inner diameter of the land hole portion 5b of the nipple hole 5, C₁ represents the dimension in the height direction of the resin supply channel 4A, Cn represents the dimension in the height direction of the resin channel 4N, and Ln2 represents the length of the land hole portion 6Nb of the coating die hole 6N. The unit of the length is “mm”, and the unit of the angle is “degree”.

TABLE 1

| Control | Embodiment | Embodiment | Embodiment | Comparative | Comparative | |
|---|---|---|---|---|---|---|
| Factor | 1 | 2 | 3 | Example 1 | Example 2 | Prior Art |
| L1 | 1.2 | 1.2 | 1.2 | 1.2 | 1.2 | no |
| dm | 0.3 | 0.3 | 0.3 | 0.3 | 0.3 | no |
| d1 | 0.4 | 0.6 | 0.8 | 0.35 | 1.1 | no |
| dn (in) | 1.7 | 1.6 | 1.5 | 1.7 | 1.5 | 1.7 |
| dn (out) | 0.26 | 0.26 | 0.26 | 0.26 | 0.26 | 0.26 |
| θ | 7 | 5 | 4 | 8 | 10 | 8 |
| C1 | 0.3 | 0.3 | 0.3 | 0.3 | 0.3 | 0.6 |
| cn | 0.3 | 0.3 | 0.3 | 0.3 | 0.3 | no |
| Ln1 | 12 | 15 | 18 | 10 | 7 | 10 |
| Ln2 | 0.5 | 0.5 | 0.5 | 0.5 | 0.5 | 0.5 |

Table 2 shows “good” or “bad” for the coating shape after the secondary coating is formed. In the table 2, with respect to the thickness deviation, “O” is filled out for an eccentricity amount of 5 μm or less, with respect to the outer-diameter variation, “O” is filled out if variation is within 1 μm from a set value, and with respect to the breaking, and “O” is filled out for no breaking. “X” is filled out for the other cases.

TABLE 2

| | Pulling | Embodiment | Embodiment | Embodiment | Comparative | Comparative | |
|---|---|---|---|---|---|---|---|
| Characteristics | velocity | 1 | 2 | 3 | Example 1 | Example 2 | Prior Art |

| | | | | | | | |
|---|---|---|---|---|---|---|---|
| Coating | 1000 | ◯ | ◯ | ◯ | ◯ | ◯ | ◯ |
| thickness | 1200 | ◯ | ◯ | ◯ | ◯ | ◯ | X |
| deviation | 1400 | ◯ | ◯ | ◯ | ◯ | ◯ | X |
| | 1600 | ◯ | ◯ | ◯ | X | X | X |
| | 2000 | ◯ | ◯ | ◯ | X | X | X |
| Outer- | 1000 | ◯ | ◯ | ◯ | ◯ | ◯ | ◯ |
| diameter | 1200 | ◯ | ◯ | ◯ | ◯ | ◯ | X |
| variation | 1400 | ◯ | ◯ | ◯ | ◯ | ◯ | X |
| | 1600 | ◯ | ◯ | ◯ | X | X | X |
| | 2000 | ◯ | ◯ | ◯ | X | X | X |
| Breaking | 1000 | ◯ | ◯ | ◯ | ◯ | ◯ | ◯ |
| | 1200 | ◯ | ◯ | ◯ | ◯ | ◯ | ◯ |
| | 1400 | ◯ | ◯ | ◯ | ◯ | ◯ | X |
| | 1600 | ◯ | ◯ | ◯ | ◯ | ◯ | X |
| | 2000 | ◯ | ◯ | ◯ | X | X | X |

As is apparent from table 2, in the case of the coating devices of the embodiment 1 to embodiment 3 for which the inner diameter d₁ of the land hole portion 6Ab of the intermediate die hole 6A of the intermediate die 2A is set to be smaller then the inner diameter dn(in) of the inlet of the taper hole portion 6Na of the coating die 2N and it is equal to 1.5 times or more and 4 times or less of the inner diameter dn(out) of the land hole portion 6Nb of the coating die 2N, the angle θ of the taper hole portion 6Na of the coating die 2N is equal to 8 degrees or less, the length Ln1 of the taper hole portion 6Na of the coating die 2N is equal to 12 mm or more, all the devices could perform excellent coating when the fiber-pulling velocity was equal to 2000 m/minute or less.

On other hand, in the coating devices satisfying the setting conditions of the comparative examples 1, 2 (i.e., do not satisfy all of the setting conditions of the above embodiments), the thickness deviation and the outer-diameter were great when the fiber-pulling velocity was equal to 1600 m/minute or more. The resin leaked to the inlet side of the nipple hole 5 at the fiber-pulling velocity of 2000 m/minute or more and solidified, and the solidified resin damaged the optical fiber inserted into the nipple hole 5, so that the breaking frequently occurred.

In the prior art coating device, the thickness deviation and the outer-diameter variation were great at the fiber-pulling velocity of ₁₂₀₀ m/minute or more, and the breaking frequently occurred at the fiber-pulling velocity of ₁₄₀₀ m/minute or more.

The above tendency was also observed to the coating devices for forming the primary coating having the outer diameter of about 160 to 190 μm.

In the embodiments, the resin supply pressure was equal to a relatively low value (about 0.4 Mpa). On the other hand, in the prior art, the resin supply pressure was equal to a high value (about 0.7 Mpa), and the prior art coating device needs a pressure-proof structure and a high equipment cost.

As described above, according to the embodiments of the present invention, in the optical-fiber resin coating resin having at least three-layer structure, the positional relationship between the intermediate die and the coating die and the parameters of the respective parts such as the dimension, etc. are optimized. This optimization suppresses occurrence of disturbance in circulating flow, so that occurrence of the thickness deviation and the outer-diameter variation of the coating resin of the optical fiber core and the adverse effects such as the breaking of the optical fiber, etc. can be prevented.

What is claimed is:

1. An optical-fiber resin coating device according to an aspect of the present invention comprises:
a nipple having a nipple hole through which an optical fiber is passed;
an intermediate die having an intermediate die through the optical fiber is passed; and
a coating die having a coating die hole through which the optical fiber is passed, the nipple, the intermediate die and the coating die being successively and superposedly disposed in the order from the upstream side to the downstream side so that the nipple hole, the intermediate die hole and the coating die hole are concentric with one another, and said coating die hole comprising a taper hole portion that is reduced in diameter in the travel direction of the optical fiber from the inlet port side of said coating die hole while having an angle of θ, and a land hole portion intercommunicating with the terminal of the taper hole portion and extending to the outlet of said coating die hole, wherein the inner diameter of the intermediate die hole is set to be smaller than the inner diameter of the inlet port of the taper hole portion of the coating die hole, the inequality: 1.5dₙ(out)≦d₁>4dₙ(out) is satisfied when the inner diameter of the intermediate die hole is represented by d₁ and the inner diameter of the land hole portion of the coating die hole is represented by dₙ (out), the angle θ of the taper hole portion of the coating die satisfies: θ≦8°, and the length Lₙ₁ of the taper hole portion of the coating die satisfies: 12 mm≦Lₙ₁.
